(19) United States
(12) Patent Application Publication
(10) Pub. No.: US 2016/0257025 A1
(43) Pub. Date: Sep. 8, 2016

(54) DEVICE AND METHOD FOR ARTIFICIALLY AGEING STONES

(71) Applicant: BAUSTOFFWERKE GEBHART & SOEHNE GMBH & CO. KG, Lachen (DE)

(72) Inventors: Hans Gebhart, Memmingen (DE); Manfred Staehle, Legau (DE)

(73) Assignee: Baustoffwerke Gebhart & Soehne GmbH & Co. KG, Lachen (DE)

(21) Appl. No.: 15/029,390

(22) PCT Filed: Oct. 13, 2014
(86) PCT No.: PCT/EP2014/071858

§ 371 Date: Apr. 14, 2016

(30) Foreign Application Priority Data
Oct. 18, 2013 (DE) 10 2013 221 219.4

(51) Int. Cl. B28D 1/00

(52) U.S. Cl. CPC B28D 1/006

(57) ABSTRACT

The invention relates to a device and to a method for artificially ageing stone blocks, in particular concrete blocks, clinker bricks and natural stone blocks. Provided is an ageing duct which comprises a base, an upper boundary and lateral boundaries. In addition, a vibration device is provided in order to make at least the base of the ageing duct vibrate. In addition, a feed device is provided in order to push at least two rows of stone blocks, which are arranged side by side in the feed direction and are formed in each case by several stone blocks placed one behind the other, through the ageing duct, wherein the stone blocks of the rows of stone blocks are placed in such a manner on the base of the ageing duct that the stone block surface of the stone blocks to be treated is aligned transversely with respect to the feed direction.

### CROSS-REFERENCE TO RELATED APPLICATIONS

This application claims priority under 35 U.S.C. §§119(a)-(d), 120, 363 and 365 to International Patent Application No. PCT/EP2014/071858, filed Oct. 13, 2014 which designated the United States and at least one other country in addition to the United States and claimed priority to German Application No. 10 2013 221 219.4 filed Oct. 18, 2013.

### STATEMENT REGARDING FEDERALLY SPONSORED-RESEARCH OR DEVELOPMENT

Not applicable.

### INCORPORATION BY REFERENCE

International Patent Application No. PCT/EP2014/071858 and German Patent Application No. 10 2013 221 219.4 are each expressly incorporated by reference herein in their entirety to form a part of the present disclosure.

### FIELD OF THE INVENTION

The invention relates to a device and to a method for artificially ageing stone blocks. The invention further relates to the use of a device for artificially ageing stone blocks.

### BACKGROUND OF THE INVENTION

A generic device and a generic method is disclosed in DE 10 2011 084 656 A1.

Walls, above all for landscaping, are produced in a preferred manner from natural or artificial stone blocks which are provided on the visible side with an irregularly relief-structured surface and/or broken edges, as are created, for example, when natural stone blocks are manually hewn.

Known in this case is also the use of split stone blocks, preferably produced from concrete. Rough stone blocks originating from stone block production can be supplied, for example, in layers to a splitting device in which the rough stone blocks are preferably divided in half. The split stone blocks created as a result are frequently designated as split stone blocks. On the side on which they have been broken, said split stone blocks comprise an irregularly structured relief surface as a result of the dividing machine. This is designated within the framework of the present invention as “a stone block surface produced as a result of splitting” or a split surface—irrespective of whether it is a split concrete block or a natural stone block.

DE 22 06 732 discloses a method and a device for splitting artificial stone block blanks. In addition, DE 33 32 041 A1 and DE 33 47 077 A1 disclose devices for producing embossed split stone blocks.

Frequently the demand made of split stone blocks is that they are not to comprise any sharp edges, whether they be produced from concrete or whether they are split natural stone blocks. Independently of this, often further treatment of the broken structure is also required. Devices for ageing stone blocks are disclosed from the general prior art for this purpose. To this end, reference is made, for example, to EP 1 699 609 B1.

During the ageing of stone blocks, in particular when these are split stone blocks, there is the problem that the surface of the stone block to be treated, i.e. as a rule the subsequent visible side of the stone block, does not form the top surface of the stone block after leaving production. In the case of the so-called split stone blocks this is produced as a result of them being formed, as a rule, from a rough stone block or a block and said block being divided, for example, into two halves. Such splitting methods are adequately familiar from the general prior art, e.g. from DE 22 06 732. The result of splitting the rough block into two split stone blocks is that the split surfaces, i.e. the stone block surfaces produced as a result of splitting, of the created stone blocks are arranged laterally and are aligned with one another.

In order to treat the surface created as a result of the splitting or in order, in general, to treat stone blocks where the surface to be treated is aligned laterally, two different methods are known. One possibility is to use ageing methods which enable the stone blocks to be treated laterally by means of corresponding treatment tools. These types of methods, however, are expensive and not efficient. Fastening chain beaters, which knock into the stone block surface of the stone blocks, to a rotating roller, for example, is known for this purpose. In the case of split stone blocks, it must be added that the stone blocks with the broken surfaces aligned with respect to one another have initially to be spatially separated from one another by an amount that enables the treatment tools to engage at all. The further possibility for further treatment or ageing lateral surfaces of stone blocks is to lift the stone blocks by means of corresponding gripper tools and to put them down such that the surface to be treated forms the top surface of the stone block.

The lifting and renewed depositing of stone blocks is on the one hand expensive, susceptible to mistakes and time-consuming. On the other hand, however, this enables the use of effective and known ageing methods which act upon the surface of the stone blocks. A plurality of ageing methods which act upon the surface of the stone blocks are known from the general prior art. A particularly suitable method is provided in EP 1 699 609 B1.

The stone blocks, which are to be treated on a stone block surface which, in the installed or laid state of the stone block, extends obliquely by 90° in relation to the top surface of the stone block, do not necessarily have to be split stone blocks. It can also be advantageous in the case of other stone blocks where a side surface subsequently forms the visible surface when said surface is aged. The problem in this connection too is that the laterally aligned side of the stone block, which subsequently forms the visible side of the stone block, does not coincide with the top surface of the stone block and consequently cannot be aged so effectively as is possible in the case of the top surface of the stone block.

The generic device and the generic method according to DE 10 2011 084 656 A1 already provides a suitable solution to this problem.

DE 10 2011 084 656 A1 discloses an ageing duct through which in each case one row of stone blocks is pushed. The duct, in this case, comprises the form of an upwardly open tube, through which the individual stone blocks or the row of stone blocks, which is formed by stone blocks arranged in rows one behind another, is pushed. In this case, the ageing duct according to DE 10 2011 084 656 A1 comprises a bend point, preferably two bend points which result in the pushed-through stone block being diverted. The stone block to be treated is introduced into the ageing duct in such a manner that the stone block surface to be treated is aligned laterally with reference to the feed direction through the ageing duct. If a split stone block is to be aged, for which purpose the device is particularly suited, the stone block surface to be treated is, as a rule, the split surface. The support onto which the stone block is placed when running though the ageing duct, is set in motion by a vibration such that the stone block vibrates. In this case, the laterally aligned side surface of the stone block, which is provided for treatment, strikes against stop elements which are integrated in the side walls of the ageing duct or are arranged there. One or both of the laterally aligned side surfaces of the stone block are consequently treated such that the stone block is artificially aged on said surfaces and on the circumferential side edges. The width of the ageing duct is adapted to the width of the stone block for this purpose, i.e. the extension thereof between the two laterally aligned side surfaces.

The device disclosed in DE 10 2011 084 656 A1 has proved to be particularly suitable for ageing split stone blocks. It has been shown, however, that the treating of specific stone block forms, in particular of stone blocks which, when seen in top view, comprise a trapezium form, is difficult. In the case of trapezoidal stone blocks which are frequently used to produce masonry, it is usual for at least one of the stone block surfaces, which extend parallel to one another and are designated typically as basic surfaces in the case of a trapezium, to form the visible side of the subsequent masonry. Consequently, irrespective of whether it is a split stone block or not, it is frequently desired that the stone blocks do not have an artificial appearance but appear naturally aged. Consequently, artificial ageing can be desired for the reasons already mentioned. Both basic surfaces of the trapezoidal stone block do not always have to be aged in this case. This depends on the use of the stone block or of the subsequent masonry. It has been shown then that treating the visible side of a trapezoidal stone block with the assistance of the ageing duct, as is disclosed in DE 10 2011 084 656 A1, is difficult. The feed device disclosed in DE 10 2011 084 656 A1, for the most part a feed punch which is to push the stone block through the ageing duct, for feeding in the case of a trapezoidal stone block engages with a surface which does not extend at right angles to the feed direction but on account of the trapezoidal form obliquely thereto. Said surface is designated in general as a leg in the case of a trapezium. The trapezoidal stone block can consequently only be pushed through the ageing duct under difficult conditions or tends to become wedged in the ageing duct.

### BRIEF SUMMARY OF THE INVENTION

An object underlying the present invention is to create a device and a method for artificially ageing stone blocks, in particular for ageing split and trapezoidal stone blocks, which makes it possible to age stone blocks in a rapid, cost-efficient, effective and reliable manner.

Said object is achieved according to the invention with regard to the device by claim 24. Said object is achieved according to the invention with regard to the method by claim 36.

A particular use of a device for artificially ageing stone blocks for ageing trapezoidal stone blocks is produced from claim 44.

In the case of a device according to the invention for ageing stone blocks, in particular concrete blocks, clinker bricks and natural stone blocks, an ageing duct which comprises a base, an upper boundary and lateral boundaries is provided. A vibration device in order to make at least the base of the ageing duct vibrate is additionally provided. The upper boundary and/or the lateral boundaries are preferably also made to vibrate. It can also be provided that the entire ageing duct is made to vibrate.

In addition, a feed device is provided in order to convey, preferably to push, at least two rows of stone blocks, which are arranged side by side in the feed direction and are formed in each case by several stone blocks placed one behind the other, through the ageing duct. The stone blocks of the rows of stone blocks are placed in such a manner on the base of the ageing duct that the stone block surface of the stone blocks to be treated is aligned transversely with respect to the feed direction.

The feature “stone block surface to be treated” is not to imply that the entire stone block surface has necessarily to be treated. It is already sufficient in the case of many applications when the stone block edges which delimit the stone block surface to be treated are treated. The mere treating of the stone block edges is to be understood within the framework of the invention as treating the correspondingly delimited stone block surface.

The lateral boundaries are spaced apart from one another in such a manner that at least two rows of stone blocks, which are arranged side by side and are formed in each case by a plurality of stone blocks placed one behind another, are able to be conveyed simultaneously and side by side in parallel through the ageing duct.

As a result of the device according to the invention, it is now also possible in an advantageous manner to age stone blocks effectively with particular forms, in particular trapezoidal stone blocks, and in particular trapezoidal split stone blocks. The present invention provides a further development of DE 10 2011 084 656 A1 in order also to be able to machine these types of stone blocks.

The invention is suitable, in principle, for treating a stone surface of an arbitrary stone block. The invention is suitable, however, in a preferred manner for treating stone blocks which, in top view, comprise the form of a trapezium; in particular, when, in this case, it is provided that at least one of the two basic surfaces of the trapezoidal stone blocks which extend parallel to one another is treated. The stone surface which is to be treated, in the case of a trapezoidal stone block therefore preferably one of the two basic surfaces, subsequently preferably forms the visible surface of the stone block, for example in a masonry wall. The trapezoidal stone block is preferably a split stone block, wherein at least one of the basic surfaces comprises a split surface, i.e. a stone block surface which has been produced as a result of splitting.

A stone block surface which is aligned transversely with respect to the feed direction is able to be treated according to the invention. In this case, this can preferably be the front surface of the stone block but also the rear surface of the stone block (in each case when viewed in the feed direction through the ageing duct). Two stone block surfaces are also able to be aged according to the invention, in this case both of the stone block surfaces are aligned transversely with respect to the feed direction, i.e. the front surface and the rear surface of the stone block (when viewed in the feed direction through the ageing duct). The device according to the invention, the method and the use enable the ageing of the front surface and of the rear surface of the stone block, consequently not just one but two stone block surfaces aligned transversely with respect to the feed direction are usually aged. The invention is to be understood in a corresponding manner.

The invention can also be combined with the features of DE 10 2011 084 656 A1 in order also to age another side surface of the stone blocks in addition to the front surface and/or rear surface. This is possible in particular in the case of stone blocks of rows of stone blocks which are conveyed through the ageing duct adjoining one of the two lateral boundaries of said ageing duct. One or both of the lateral boundaries can be developed, in this case, corresponding to DE 10 2011 084 656.

The present invention differs from the device according to DE 10 2011 084 656 by two basically new findings. It is now provided that the stone blocks to be aged are placed in such a manner onto the base of the ageing duct that the stone block surface of the stone block to be treated is aligned transversely with respect to the feed direction, that is to say that the stone block surface (when viewed in the feed direction) forms the front surface and/or the rear surface of the stone block when the stone blocks are conveyed through the ageing duct. In the case of the device according to the prior art it was provided that the stone block surfaces to be aged are aligned laterally. The advantage of the device according to the invention is that now even trapezoidal stone blocks are easily able to be aged. In contrast to the generic document, the two basic surfaces of the trapezoidal stone block extending in parallel are situated on the front and the rear surface (when viewed in the feed direction) such that the trapezoidal stone block is easily able to be pushed through the ageing duct by a feed device which engages with the rear surface of the stone block. The inventor has recognized, in this case, that it is possible to dispense with the lateral alignment of the stone block surface to be treated when at least two rows of stone blocks arranged side by side are pushed at the same time through the ageing duct. In this connection, this is the second significant difference to the generic device where it was provided that in each case only one stone block or one row of stone blocks is pushed through the ageing duct. In particular, in the case of treating trapezoidal stone blocks, a good treatment result is produced as a result of pushing two or more rows of stone blocks side by side through as the stone blocks are treated in a reciprocally abrasive manner.

The energy necessary for the ageing process is applied by a vibration device which is preferably arranged below the base of the ageing duct onto which the stone blocks are placed. The vibration device can comprise one or several vibrations units. The use of a vibrating table is also possible. It has proved to be particularly advantageous within the framework of the invention when the vibration is effected in such a manner that the stone blocks are pushed upward from the base of the ageing duct. The stones consequently bounce upward in the ageing channel.

It is advantageous according to the invention when the vibration is effected in the vertical direction. In principle, however, it is also possible for the vibration device to generate a lateral vibration and/or a vibration in and against the feed direction in addition to or as an alternative to the vertical components. It is, however, advantageous when the main vibration direction is aligned vertically.

The ageing duct of the device according to the invention can preferably additionally comprise at least two sections, wherein the stone blocks run through a first section in a first feed direction and wherein a second section extends at an angle to the first section such that the feed direction of the stone blocks is deflected and they are moved in a second feed direction. The two feed directions consequently do not lie on one axis.

To improve the ageing of the vertically extending stone block edges, it can preferably be provided that the ageing channel comprises at least two, preferably three sections or even more sections. The stone block, in this case, initially runs through the first section in a first feed direction. The following second section extends in the case of said preferably provided development at an angle in relation to the first section such that the stone block extends at an angle to the second section such that the feed direction of the stone block is deflected and the stone block is moved in a second feed direction.

The deflecting results, in an idealized view, in a preceding stone block changing its direction in relation to a following stone block. Depending on the direction (to the left or to the right) in which the second section extends at an angle in relation to the first section, one of the two vertical rear stone block edges of the stone block is moved back in relative terms in relation to the other vertical rear stone block edge. The vertical stone block edges are consequently pushed toward one another in the feed direction. When viewed in the feed direction, one vertically extending stone block edge of the stone block consequently protrudes to the rear compared to the other stone block edge. This results in a following stone block striking against the rearwardly protruding vertical stone block edge of the preceding stone block.

It has been shown in tests that in particular the vertically extending front edge, realized on the same end face, of the following stone block strikes against the rearwardly protruding vertically extending stone block edge of the preceding stone block. This results in a rear, vertically extending stone block edge of a preceding stone block and a front, vertically extending stone block edge of a following stone block being reciprocally aged. In dependence on the intensity of the vibration and in dependence on the strength of the bend or directional change generated by two sections of the ageing duct which are at an angle to one another, an almost arbitrary ageing result can be achieved on the two vertically extending stone block edges.

The above view is idealized for the purposes of illustration. The described displacement of the vertical rear stone block edges, looked at as an example, depends, on the one hand, on the strength of the directional change between the sections and, on the other hand, also on the thrust or pressure at which the stone blocks are pushed through the ageing duct. In addition, the idealized view also depends on how closely the rows of stone blocks located side by side adjoin one another. The inventor, however, has recognized that abrasive treating and consequently ageing of the vertical stone block edges always occurs as a result of the directional change or the diversion of the stone blocks when they are pushed from one section into the next section. The achievement of the diverting is at least that a rear stone block surface (rear surface) of a preceding stone block is pushed against a front stone block surface (front surface) of a following stone block. As a result, the stone block surfaces rub both against one another and against the corresponding vertical stone block edges of the stone block surfaces. As a result of the stone blocks also vibrating at the same time, a desired ageing of the stone block surfaces and in particular of the vertical stone block edges is achieved.

It is also advantageous, in this case, that as a result of the stone blocks being pushed through the ageing duct, the stone blocks of the rows of stone blocks remain in contact, in particular even during the diversion or the change in direction, as a result of which the desired mechanical or abrasive treatment of the stone block surfaces and of the adjoining stone block edges is produced on account of the displacement of the stone block surfaces of two adjoining stone blocks of one row of stone blocks, produced during the diversion or the change in direction.

The strength of the desired processing can be influenced correspondingly in this case by the thrust or the pressure at which the stone blocks are pushed through the ageing duct and the intensity of the vibration. A further potential influence is the size of the diversion or of the change in direction between the sections.

It is advantageous, in this case, that the ageing on the vertically extending stone block edges is generated by the stone blocks themselves. As a result, an ageing appearance can be achieved which is very close to the ageing in a stone drum or exceeds this result. The wear on the ageing duct in this regard is also small once no further materials participate.

In the case of the following stone block, as has been described above, the ageing of the vertically extending front stone block edge is achieved by the preceding stone block. In an analogous manner, in the case of the following stone block, the vertically extending rear stone block edge thereof is also aged by a further following stone block.

The preferably provided development of the ageing duct with two or several sections which extend at an angle to one another makes it possible with simple means for a front vertically extending stone block edge and a rear vertically extending stone block edge to be treated or aged in a particularly effective manner. This can be achieved with only one single change in direction inside the ageing duct.

Another advantage of the present invention is additionally that on account of the arrangement of two or several rows of stone blocks arranged side by side, the stone blocks of the rows of stone blocks are reciprocally treated in particular in the region of the edges and in particular as a result of the preferably forced change in direction.

In a particularly advantageous embodiment of the invention, it can be provided that the ageing channel comprises at least one third section. The third section can extend, in this case, at an angle to the second section such that the stone block is once again deflected and is moved in a third feed direction. In this case, it can be provided according to the invention that the diversion of the stone block, which is experienced by said stone block when the stone block is moved from the second section into the third section, is effected in the reverse direction to the diversion of the stone block on entry into the second section. For example, the stone block can be diverted to the left from the first section into the second section and to the right from the second into the third section (or both diversions are effected in the reverse direction). The achievement here is that the vertically extending stone block edges of the stone block which are not yet aged during the first diversion or during the first change in direction are also able to be aged in a particularly effective manner.

It can be provided according to the invention that as a result of the angled arrangement of the third section in relation to the second section, the diversion between the first and the second section is reversed again. In this case, it can be provided that the first feed direction corresponds to the third feed direction, i.e. that the feed directions run parallel to one another. This is, however, optional. A realization of this type can be provided among other things in order to arrange the ageing duct in a particularly space-saving manner on the support or in order to push the stone blocks through the ageing duct in as unimpeded a manner as possible by means of a feed member, for example a conveying punch.

The individual rows of stone blocks are formed in each case by a plurality of individual stone blocks which are arranged in each case one behind another.

The stone blocks of the rows of stone blocks preferably all comprise the same format, i.e. the same form, height, length and width.

Within the framework of the present invention, the terms “horizontally extending stone block bottom edge” or “stone block top edge” are to be understood as the stone block bottom edges and the stone block top edges which extend horizontally and transversely to the feed direction when the stone block is conveyed through the ageing duct, that is to say the stone block top edges and stone block bottom edges which, when viewed in the feed direction, are situated on the front surface and the rear surface of the stone block when they are conveyed through the aging duct. Within the framework of the present invention, it is not a question of ageing the stone block top edges and stone block bottom edges which extend laterally, that is to say from front to back along the stone block when it is pushed through the ageing duct, as said lateral edges are not, as a rule, visible in the subsequent laid state of the stone block.

It can be provided according to the invention that the feed device advances the rows of stone blocks at intervals, wherein one interval includes advancing the feed device, stopping and preferably reversing the feed device in order to enable the stone blocks to be shaken free. The inventor has recognized that advancing at intervals is particularly suitable in order to age the stone blocks according to the invention.

It can be provided that an “endless” train is pushed through the ageing duct, that is to say that new stone blocks are pushed into the ageing duct from behind in regular cycles such that the rows of stone blocks are continually pushed through the ageing duct in such a manner that in front of each stone block another stone block precedes and a stone block follows. It is advantageous when the rows of stone blocks in the ageing duct are not interrupted, but one stone block continually follows the next. This can be achieved, for example, as a result of the feed device comprising a punch and the punch retracting in regular cycles, further stone blocks being placed in position and being pushed in by the punch until the new stone blocks connect to the end of the preceding stone blocks. All the stone blocks can then be pushed forward again by the punch. A plurality of possibilities is technically conceivable for this.

According to the invention, a charging region can be provided at the start of the ageing duct and the new stone blocks (or even just one new stone block) are connected to the end of a row of stone blocks situated in the ageing duct. The new stone blocks (or the new stone block) consequently become part of the row of stone blocks.

The advancing at intervals, which primarily has nothing to do with the feeding of further stone blocks, and in particular that stopping and preferably reversing is provided within the framework of the interval, has the decisive advantage that the stone blocks are able to be shaken free, that is to say that the stone blocks increase their spacing to one another on account of the introduced vibrations. As a result, on the one hand a particularly good reciprocal treatment of the stone blocks is achieved, that is to say that the stone blocks knock against one another in a particularly effective manner. On the other hand, jamming of the stone blocks in the ageing duct is avoided or reduced.

The feed device can comprise one feed element for all or separate feed elements, for example punches, for each row of stone blocks. The rows of stone blocks are preferably conveyed forward at the same time and in a uniform manner by the feed device. It can also be provided, however, for certain applications that the rows of stone blocks are conveyed forward in an irregular and/or offset manner and/or at staggered intervals and/or along different path sections.

As a result of the stone blocks being pushed through the ageing duct in rows of stone blocks and the base of the ageing duct vibrating, the stone blocks of a row of stone blocks placed one behind another rub or vibrate against one another. As a result, in particular, the front horizontally extending stone block top edge and the front horizontally extending stone block bottom edge of a stone block vibrates and rubs against the rear surface and in particular against the horizontally extending stone block top edge and stone block bottom edge of a preceding stone block at that location. The horizontal stone block edges are consequently aged in particular by in each case preceding or following stone blocks of the same row of stone blocks.

The ageing of the horizontally extending stone block edges can be further improved as an option by the following measures.

It can be provided according to the invention that the vertical spacing between the upper boundary and the base of the ageing channel is chosen in such a manner that, brought about by the vibration, the stones blocks strike against the upper boundary.

In contrast to the generic device, it is an advantage of the present invention that the ageing duct comprises an upper boundary, preferably an upper cover. As a result of the vibration, the stone blocks of the rows of stone blocks are bumped upward and are knocked against the upper boundary on account of the dimensioning of the spacing between the upper boundary and the base, in particular with the front and rear horizontally extending stone block top edge which is consequently effectively aged, in particular when further measures described below are taken. The intensity of the ageing and whether the upper boundary brings about an ageing at all, depends among other things on the intensity of the vibration, the spacing between the upper boundary and the base and the format of the stone blocks. A desired ageing appearance can be achieved as a result of matching said values in a suitable manner.

The front and the rear horizontally extending stone block bottom edge is additionally aged when falling back onto the base of the ageing duct and also when pushing off from the base of the ageing duct, that is to say the stone block bottom edge on the front and on the rear surface. As a result of further measures described below, it is also possible, in this case, to strengthen ageing in this region too.

As already described above, as a result of the device and the method according to the invention both the vertical stone block edges and the front and rear stone block bottom edges and stone block top edges can be aged in an efficient manner. In contrast to this, the generic device aged the laterally and horizontally extending stone block edges.

It is advantageous when the upper boundary completely conceals or covers the stone blocks of the rows of stones to be conveyed through the ageing channel, in particular in the region which is relevant to the ageing of the horizontally extending stone block top edges.

The upper boundary is preferably realized as a cover. The upper cover preferably completely covers the region relevant to the ageing.

The upper cover can be realized as a rigid or fixed cover. Fixed, in this case, means a strength of steel. However, it can also be provided that the upper cover is realized in a resilient or damping manner. This can be achieved, for example, as a result of realization from a resilient or flexible material, e.g. a soft plastics material, elastomer or a suitable rubber. As an alternative to this or in addition to it, the upper cover can also be mounted or suspended in a resilient or flexible manner. It can be particularly advantageous to mount or suspend a fixed cover in a resilient or flexible manner.

The upper boundary or the upper cover does not necessarily have to be closed forming a single surface. Slots, recesses, bores or other openings can be provided in particular. Realization from bars which are arranged closely side by side and preferably extend parallel to one another is also possible.

In a structural development of the invention, it can additionally be provided that the base of the ageing duct is provided with at least one elevation.

Several elevations are preferably provided. The elevations can be island-shaped elevations, but also ramps or other chicanes which preferably extend transversely to the feed direction from one lateral boundary of the ageing duct to the oppositely situated lateral boundary of the ageing duct. Mixtures are also possible here. The elevations are preferably realized as ramps, as a result of which the stone blocks are raised when they are pushed or conveyed over the ramps.

The advantage of the elevations is that the pushed-through stone blocks are raised as a result of said elevations, as a result of which the stone block top edges strike against the upper boundary in a particularly strong manner and, in particular, the stone block bottom edges are also aged in a stronger manner when they fall back down. In addition, the stone block bottom edges also undergo a stronger ageing effect as a result of them contacting the elevations.

It is advantageous when the upper boundary comprises a rise or rises in the region above the elevation or elevations arranged in the base in order to enable the stone blocks to be raised by the elevation or elevations. The advantage of this is that the upper boundary is able to be moved closer to the base in other regions, only in the regions in which the elevation is realized is a larger space upward available for the stone block or it is preferably at least ensured that the spacing between the top surface of the elevation and the bottom surface of the rise corresponds at least to the spacing which is present between the base and the upper boundary when no rise is present.

It is advantageous when the rise realizes a stop edge. The stop edge can be individual stops but also one edge that extends over part or completely over the entire width of the ageing duct, the extension of which transversely to the feed direction can preferably correspond approximately to the extension of the elevation. The stop edge preferably extends from one boundary to the oppositely situated lateral boundary of the ageing duct.

The stop edge makes it possible for the stone block edges to be knocked in a particularly efficient manner. As a result of the elevation in the base in conjunction with the stop edge, a particularly strong ageing effect is obtained.

Realizing one or more stop edges on the upper boundary can also be provided according to the invention, in particular in conjunction with the elevations in the base, without a rise being provided.

It can additionally be provided according to the invention that the base and/or the at least one elevation and/or the upper boundary and/or the at least one stop edge and/or the lateral boundaries are provided with stop projections and/or abrasive elements and/or weld points and/or weld beads. In addition to this or as an alternative to it, an abrasive surface can also be provided.

In a structural development of the invention, it can additionally be provided that the ageing channel comprises a width which extends transversely with respect to the feed direction and makes it possible to push at least two rows of stone blocks arranged side by side, preferably one complete layer of stone blocks, through the ageing channel. A complete layer of stone blocks, in this case, is to be understood as a production layer of stone blocks, as are typically produced. A production layer, in this case, can include two, three, four, five or even more rows of stone blocks.

The stone blocks of the stone block layer preferably all comprise the same format, i.e. the same form, height, length and width.

The device according to the invention is particularly suitable for ageing stone blocks which in top view comprise the form of a trapezium, wherein the trapezoidal stone blocks are placed in such a manner onto the base of the ageing duct that the basic surfaces of the trapezoidal stone blocks extending parallel to one another are aligned transversely with respect to the feed direction.

In an advantageous further development of the invention, additional stop members can be provided which are positioned in a stationary manner and/or are positionable in a controlled manner such that bevels and/or recesses and/or phases of a stone block surface to be treated knock against them, as a result of the vibration of the base.

The stop members can be developed, for example, in the manner of a scale or a slate, these preferably being aligned in such a manner that the top surface thereof, developed by a plurality of scales or slates, is aligned in opposition to the throughput direction so that the stone blocks strike particularly well or strongly thereon. The stop member can preferably be mounted on one or both lateral boundaries, for example extending vertically. The stop member can also project into the conveying path of the stone blocks as a result of a recess in the lateral boundary or in the ageing duct. The stop members can, where applicable, be realized or fastened in a resilient or flexible manner. The stop members can be developed or arranged in such a manner that only the corners or edges of the stone blocks knock against them. It can be advantageous, however, when the stop members project so far into a feed path/conveying path of the stone blocks that the space available for conveying-through is narrowed to such an extent that the stop member also treats a stone block surface to be treated or at least unwanted projections or bulges of the stone block surface are treated.

As an alternative to this or in addition to it, additional stop members can also be provided which are positioned by means of a resilient or flexible element in such a manner that bevels and/or recesses and/or phases and/or bulges and/or projections of a stone block surface to be treated knock against them as a result of the vibration of the base, and/or the ageing duct is narrowed by the additional stop members such that the stone blocks are pressed against the stop members, the stop members yielding on account of the resilient or flexible element when the stone blocks are conveyed in the feed direction through the ageing duct.

The resilient or flexible element can be an arbitrary spring or a rubber or an elastomer, for example in block form. In one development of the invention it can be provided that the stop members vibrate.

It can be provided according to the invention that the angle, i.e. the directional change, about which the stone blocks are optionally diverted, between the first section and the second section and/or between the second section and the third section or further sections is between 1° and 45°, preferably between 1° and 25°, in a further preferred manner between 1° and 15°, in a particularly preferred manner between 1° and 10° and quite especially preferred between 3° and 7°. In the case of the above angle specifications, 0° would signify that no diversion is present.

In one development of the invention, it can be provided, where applicable, that the base is angled, that is to say falls away or ascends in the feed direction. Effects can be achieved as a result of both measures, either a lighter pushing-through or the supporting of a reverse movement when the feed device does not push.

The ageing duct can preferably comprise a width, i.e. an extension between the two lateral boundaries of at least 15 cm, preferably at least 30 cm, in a further preferred manner at least 45 cm, in a particularly preferred manner at least 60 cm and quite particularly preferred at least 80 cm. The width is preferably a maximum of 150 cm, in a particularly preferred manner a maximum of 120 cm. A width of the ageing duct of between 70 cm and 150 cm, in particular between 90 cm and 120 cm is particularly suitable, in particular in order to age an entire production layer.

The ageing duct can preferably comprise a height, i.e. an extension between the base and the upper boundary of at least 5 cm, preferably at least 8 cm, in a further preferred manner at least 10 cm and in a particularly preferred manner at least 15 cm. The height is preferably a maximum of 40 cm, in a particularly preferred manner a maximum of 30 cm. A height of the ageing duct of between 5 cm and 30 cm, in particular between 10 cm and 20 cm is particularly suitable.

In principle, the base of the ageing duct can also be directly the top surface of a vibration table, but also an arbitrary other support which forms the ageing duct together with the lateral boundaries and the upper boundary. The elements are formed from metal, preferably steel or stainless steel.

It can be advantageous when the aged stone blocks, after leaving the ageing duct, are moved so that they are spaced apart such that stone block dust and stone block residue which has accumulated between the aged stone blocks is able to be removed, preferably blown out.

It is advantageous when the device according to the invention is combined with a device which produces split stones.

The device according to the invention is particularly suitable for ageing stone blocks where at least one of the stone block surfaces to be treated is a stone block surface produced as a result of splitting. The term “stone block surface to be treated” is to be understood as at least one of the two stone block surfaces aligned transversely with respect to the feed direction of the stone blocks. It can also be the two stone block surfaces aligned transversely with respect to the feed direction of the stone blocks.

In the case of the method according to the invention for artificially ageing stone blocks, in particular concrete blocks, clinker bricks and natural stones, it is provided that the stone blocks are conveyed through an ageing channel. The stone blocks are placed in this case in such a manner on a base of the ageing channel that a stone block surface of the stone blocks to be treated is aligned transversely with respect to the feed direction of the stone blocks through the ageing channel. According to the invention, it is additionally provided in this case that several stone blocks are combined to form a row of stone blocks placed one behind another and at least two rows of stone blocks arranged side by side with reference to the feed direction are conveyed together through the ageing duct. According to the method according to the invention, it is additionally provided that the stone blocks, whilst they are being conveyed through the ageing channel, are made to vibrate such that the stone blocks strike against an upper boundary of the ageing channel.

The advantages of the method according to the invention are produced in an analogous manner from the realizations concerning the device according to the invention and likewise, the differences to the generic method where processing is effected offset by 90° and where only one row of stone blocks is pushed through the ageing duct. According to the invention, at least two rows of stone blocks, preferably even an entire production layer divided into rows of stone blocks, are now aged.

It is advantageous when at least one change in direction is forced on the stone blocks which run through the ageing channel.

According to the method according to the invention it is further preferably provided that at least two changes in direction are forced on the stone blocks which run through the ageing channel.

It is additionally advantageous in the case of the method according to the invention when the vertical spacing between the upper boundary and the base of the ageing duct is adapted in such a manner to the height of the stone blocks that the stone blocks strike against the upper boundary as a result of the vibration.

It is additionally advantageous in the case of the method according to the invention when the stone blocks are pushed at intervals through the ageing duct by a feed device, according to which one interval includes advancing the feed device in the feed direction, stopping and preferably reversing the feed device against the feed direction in order to enable the stone blocks to be shaken free.

It is additionally advantageous in the case of the method according to the invention when the stone blocks run over at least one elevation, preferably a ramp-shaped elevation, whilst being pushed through the ageing duct and at the same time preferably strike against the upper boundary.

It can be provided additionally in the case of the method according to the invention that in top view, the stone blocks comprise the form of a trapezium, wherein the stone blocks are aligned in such a manner prior to being pushed through the ageing duct that the basic surfaces of the trapezoidal stone blocks extending parallel to one another are aligned transversely with respect to the feed direction.

It can be provided additionally in the case of the method according to the invention that at least one of the stone block surfaces of the stone blocks to be treated is a stone surface produced as a result of splitting.

A particularly advantageous use of a device for artificially ageing stone blocks, in particular concrete blocks, clinker bricks and natural stone blocks, is produced when said device comprises the following features and is used for ageing stone blocks which, in top view, comprise the form of a trapezium. The device comprises the following features for this purpose:
an ageing duct with a base, an upper boundary and lateral boundaries, wherein the stone blocks are placed in such a manner onto the base that a stone block surface of the stone blocks is aligned transversely with respect to a feed direction of the stone blocks through the ageing duct;
a feed device in order to convey the stone blocks through the ageing duct; and
a vibration device in order to make the stone blocks vibrate whilst they are being pushed through the ageing duct such that the stone blocks strike against the upper boundary of the ageing duct.

The ageing duct preferably comprises at least two sections, wherein the stone blocks run through a first section in a first feed direction and wherein a second section extends at an angle to the first section such that the feed direction of the stone blocks is diverted and they are moved in a second feed direction.

In a preferred manner, the trapezoidal stone blocks are equal-sided, i.e. the surfaces which are not basic surfaces are the same length. However, it is also possible to age non-equal-sided trapezoidal stone blocks using the device. The trapezoidal stone blocks preferably comprise a uniform height. However, it is also possible to age trapezoidal stone blocks with a height which ascends or falls away from the front surface to the rear surface and/or from one side to another side.

Preferably at least one of the stone block surfaces of the trapezoidal stone blocks to be treated is a stone block surface produced as a result of splitting. The term “stone block surface to be treated” is to be understood as at least one of the two stone block surfaces which are aligned transversely with respect to the feed direction of the stone blocks. This can also be the two stone block surfaces which are aligned with respect to the feed direction of the stone blocks.

The features described above and below with reference to the device according to the invention can be used individually or in arbitrary combination with one another for ageing trapezoidal stone blocks also within the framework of the method according to the invention and of the use according to the invention.

Advantageous further developments and arrangements are produced from the further dependent claims. An exemplary embodiment is shown schematically below by way of the drawings, in which:

### BRIEF DESCRIPTION OF THE DRAWINGS

FIG. 1 shows a side view of a preferred embodiment of a device according to the invention;

FIG. 2 shows a top view of a preferred embodiment of a device according to the invention, an upper boundary of the ageing duct having been removed;

FIG. 3 shows a view into the ageing duct with a representation of an elevation in the base of the ageing duct and a rise in the upper boundary of the ageing duct;

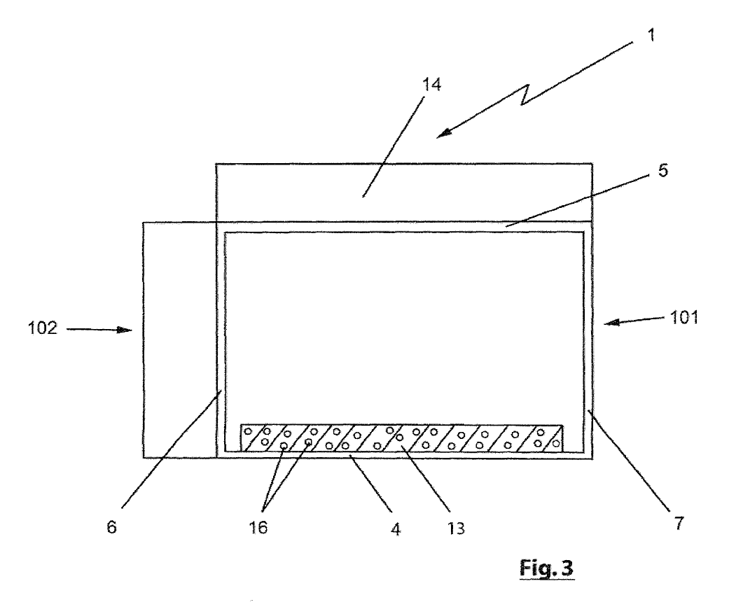

FIG. 4 shows a longitudinal section through the ageing duct in a region in which the base comprises an elevation and the upper boundary comprises a rise;

FIG. 5 shows a perspective representation of a stone block to be aged; and

FIG. 6 shows a top view of a block from which two split stone blocks are produced.

### DETAILED DESCRIPTION

The exemplary embodiment shows a device for artificially ageing stone blocks and describes a corresponding method and a particular use. The stone blocks used in the exemplary embodiment are so-called split stone blocks which are preferably produced from concrete. The device according to the invention, the method and the use are, however, not restricted to this, rather all the features shown below can also be used for ageing in the case of arbitrary other stone blocks, in particular also in the case of clinker bricks and natural stone blocks and also irrespective of whether the stone blocks comprise a split surface or not.

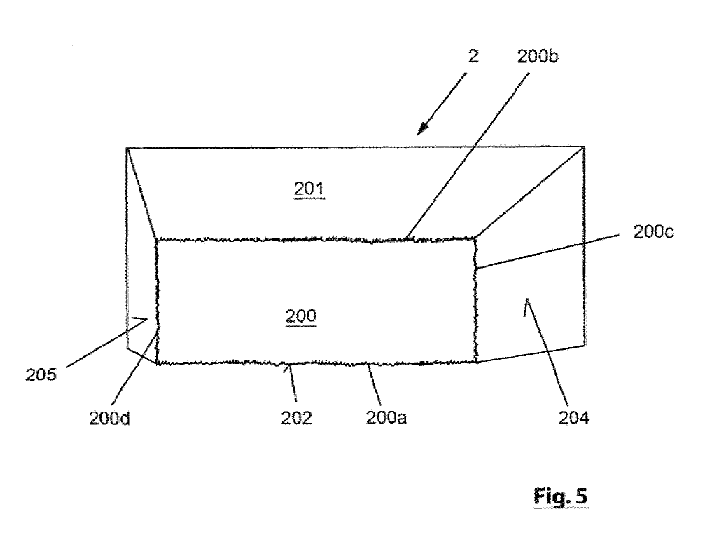

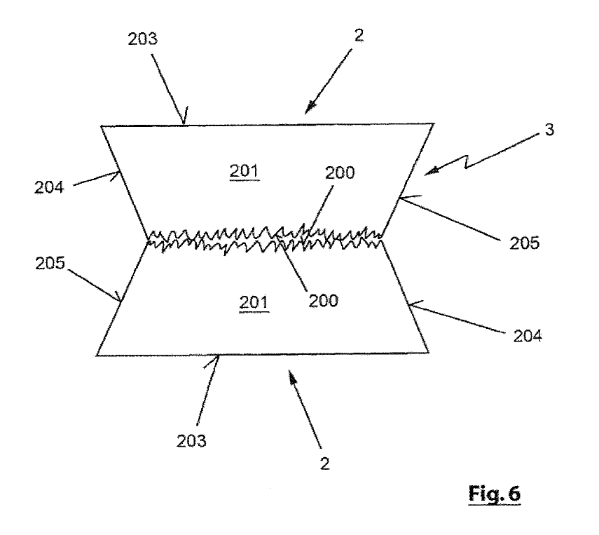

As can be seen from FIGS. 5 and 6, a specific stone block shape, namely a trapezoidal stone block, is shown in the exemplary embodiment to explain the principle. The device according to the invention and the method according to the invention are particularly suitable for artificially ageing trapezoidal stone blocks, however, the device according to the invention and the method and also the exemplary embodiment are not restricted to this.

The device according to the invention and the method according to the invention are also particularly suitable for artificially ageing stone blocks where at least one of the stone block surfaces to be treated is a stone surface produced as a result of splitting.

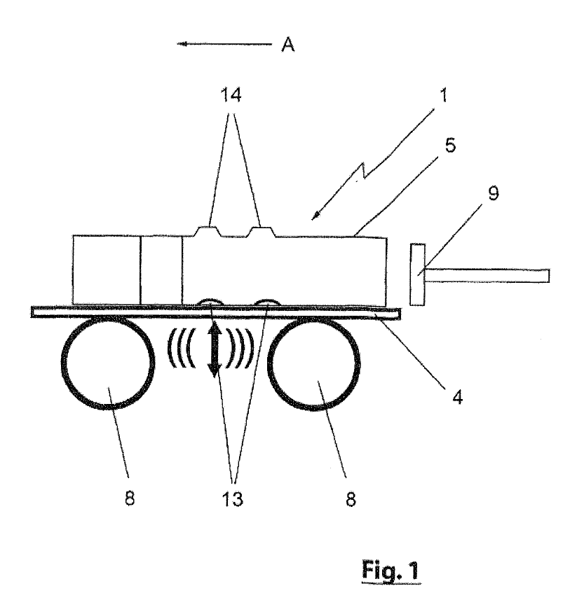

As can be seen from FIG. 1, the device according to the invention comprises an ageing duct 1 for artificially ageing stone blocks 2. The stone blocks 2 to be aged in the exemplary embodiment are shown in more detail in FIGS. 5 and 6.

The stone blocks 2 comprise a front surface 200, a top surface 201, a bottom surface 202, a rear surface 203 and lateral surfaces 204 and 205.

The stone blocks 2 shown in FIGS. 5 and 6 comprise, in top view, a trapezoidal form. The front surface 200 and the rear surface 203 provide the basic surfaces of the trapezium, that is to say the two stone block surfaces which extend parallel to one another. The longer basic surface is generally designated as the base and in the present case provides the rear surface 203. However, this is not important within the framework of the invention. The two stone block surfaces adjoining the basic surfaces are generally designated as legs in the case of a trapezium. This can be an isosceles trapezium, that is to say that the two surfaces which are basic surfaces are the same length. Stone blocks with a trapezoidal form in the majority of cases comprise the form of an isosceles trapezium. Using the device according to the invention and the method, however, stone blocks which comprise a non-isosceles trapezium form are also able to be aged.

FIGS. 5 and 6 are in each case to show stone blocks 2 with an isosceles trapezium form. In addition, the stone blocks comprise a uniform height (extension from the bottom surface 202 to the top surface 201). In FIG. 5, the stone block shown there is somewhat distorted and shown in perspective, in particular in order to be able to designate the surfaces in a comprehensible manner.

The front surface 200 and/or the rear surface 203 of the stone block 2 can be aged using the device according to the invention. Treatment of the front surface 200 and of the rear surface 203 is provided in the exemplary embodiment. It can be sufficient for many applications just to age one surface, preferably the front surface 200. Using the device according to the invention, however, it is easily possible to age both the front surface 200 and the rear surface 203.

As can be seen from FIG. 6, split stone blocks are typically generated as a result of splitting a larger splitting block 3. The split stone blocks, in this case, comprise a broken surface essentially on one stone block surface. However, two broken surfaces can also be generated. In the exemplary embodiment, the front surface 200 comprises a correspondingly broken surface. However, this could also be the rear surface 203 or the front surface 200 and the rear surface 203. The stone blocks 2 are frequently laid so as to interlock in such a manner that only the broken surface and the adjoining edges can be seen. The solution according to the invention is also suitable, however, when two stone block surfaces which are oppositely aligned are to be treated.

The broken surface is also designated as a “stone block surface produced as a result of splitting” within the framework of the invention.

As can be seen from FIG. 5, the front surface 200 is delimited by a horizontally extending stone block bottom edge 200a, a horizontally extending stone block top edge 200b and two vertically extending stone block edges 200c and 200d. The stone block bottom edge 200a and the stone block top edge 200b extend substantially transversely with respect to the throughput direction A, when the stone block 2, as will be described in more detail below, is introduced into the ageing duct 1 and conveyed through it.

The throughput direction A, which is shown in FIGS. 1, 2 and 4 by way of the direction arrow A, essentially provides a main feed direction. As will be indicated in more detail below, it is provided in the exemplary embodiment that the ageing duct 1 is developed such that the stone blocks 2, which run through the ageing duct 1, carry out two changes in direction. Nevertheless, the stone blocks 2 are moved overall, with reference to the entire ageing duct 1, in the arrow direction A.

The exemplary embodiment is not restricted to one or several directional changes having to be provided. The features of the exemplary embodiment can also be realized without changes in direction and in particular can be combined with one another in an arbitrary manner.

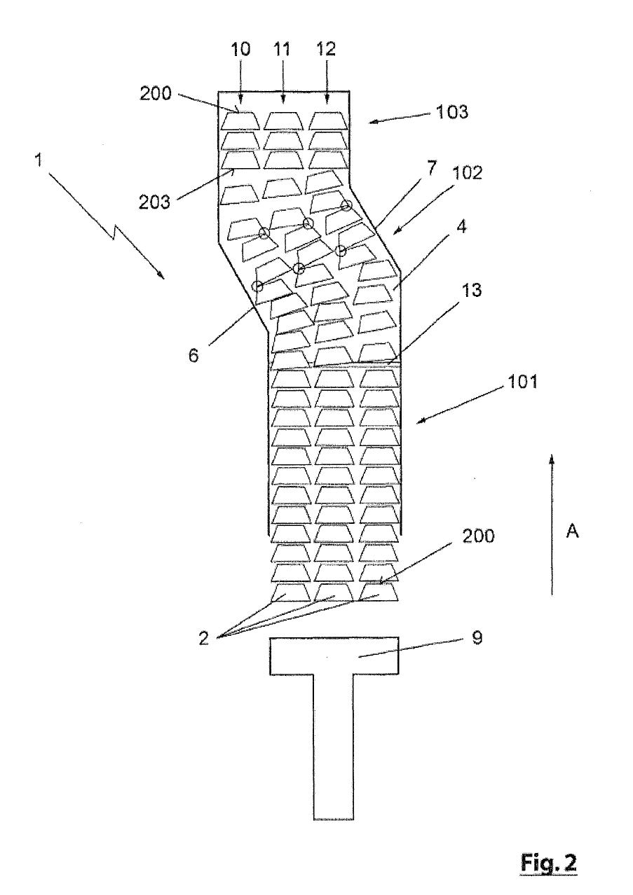

As can be seen from FIGS. 1 and 2, the ageing duct 1 comprises a base 4, an upper boundary 5 and lateral boundaries 6, 7.

The lateral boundaries 6, 7 can be arbitrary side walls, preferably continuous or closed wall elements or other delimiting elements, for example uniformly positioned bars or the like, the object of which is to give direction to the stone blocks 2 pushed through the ageing duct 1, that is to say to avoid them falling out of the ageing duct 1. In addition, the lateral boundaries 6, 7 serve for the purpose of ageing the vertical stone block edges 200c, 200d, correspondingly adjoining the lateral boundaries 6,7, of the stone blocks 2 which run through the ageing duct 1 adjacent the lateral boundaries 6,7, by said stone block edges striking against the lateral boundaries 6, 7 and being treated in an abrasive manner.

The base 4, the lateral boundaries 6, 7 and the upper boundary 5 can be realized, for example, from metal, in particular from steel, in a particularly preferred manner from stainless steel.

As can be seen from FIG. 1, a vibration device 8 is additionally provided in order to make at least the base 4 of the ageing duct 1 vibrate. The vibration device 8 can be developed in an arbitrary manner, for example shaker motors can be used. In FIG. 1, the movement of the base 4 is symbolized by the double arrow. The base 4 is moved in the exemplary embodiment preferably in such a manner that the stone blocks 2 lying thereon are moved up and down essentially as a result of the vibration, that is to say “bouncing” on the base 4 or in the ageing duct 1. In the exemplary embodiment, the direction of movement is consequently a movement perpendicular to the throughput direction or perpendicular to the base 4.

As can be seen additionally from FIGS. 1 and 2, the device according to the invention comprises a feed device 9 in order to push at least two rows of stone blocks arranged side by side in the feed direction through the ageing duct 1. The ageing duct 1 comprises a width, that is to say an extension transversely to the feed direction, which makes it possible to age at least two rows of stone blocks side by side.

Three rows of stone blocks 10, 11, 12 are shown in the exemplary embodiment. An arbitrary other number of rows of stone blocks, which is greater than or equal to two can be conveyed through the ageing duct 1. The ageing duct 1 is preferably developed in such a manner or comprises such a width that an entire production layer of stone blocks is able to be pushed through said ageing duct by means of the feed device 9.

The rows of stone blocks 10, 11, 12 are formed in each case by several stone blocks 2 arranged one behind another, that is to say the rows of stone blocks 10, 11, 12 are formed in each case by individual stone blocks 2 which are in rows one behind another. They are placed in such a manner onto the base 4 of the ageing duct 1 that the stone block surfaces to be treated, the front surface 200 and the rear surface 203 in the exemplary embodiment, are aligned transversely to the feed direction (arrow direction A) of the ageing duct 1.

As can be seen from FIG. 2, the ageing duct 1 preferably shown in the exemplary embodiment comprises at least two sections, wherein the stone blocks 2 run through a first section 101 in a first feed direction and wherein a second section 102 extends at an angle to the first section 101 such that the feed direction of the stone blocks 2 is diverted and they are moved in a second feed direction.

It can be provided that the first section 101 is short or is used for positioning the stone blocks 2 and consequently the second section 102 already starts directly at the beginning of the ageing duct 1 or at a short spacing after the beginning of the ageing duct 1.

It is provided in the exemplary embodiment that the ageing duct 1 comprises a third section 103, wherein the third section 103 extends at an angle to the second section 102 such that the stone blocks 2 are diverted once again and are moved in a third direction.

In the exemplary embodiment, the third direction corresponds at least approximately, preferably precisely, to the first feed direction. The stone blocks 2 are consequently diverted laterally by the second section 102 on the plane predetermined by the base 4, in the exemplary embodiment to the left when looking in the throughput direction. In the third section 103, the stone blocks 2 are once again diverted laterally in the plane of the base 4 to the right in the exemplified embodiment.

It is advantageous when the stone blocks 2 are diverted in opposite directions in the case of two changes in direction.

The changes in direction, which the stone blocks 2 carry out when running through the sections 101, 102 and 103, have an effect which is very advantageous to the ageing process and is shown particularly well in a schematic representation in FIG. 2.

For drawing reasons, the stone blocks 2 are shown spaced apart from one another inside the rows of stones 10,11,12. The stone blocks assume a spacing in particular when said stone blocks are shaken free after a reversing of the feed device. As a rule, the feed device pushes the stone blocks together such that they abut against one another, i.e. contact one another, in particular when the feed device conveys the stone blocks forward.

The deflection of the stone blocks 2 as a result of the change in direction produced by the sections 101,102, 103—when looked at in an idealized manner—results in a rear vertically extending stone block edge of a preceding stone block 2 knocking against a front vertically extending stone block edge of a following stone block 2. As a result, the two edges are aged. The effect is strongest in the region of the interface between the sections 101, 102 103. As a result of the vibration of the base 4, the ageing effect, in this case, is strengthened even more. The collisions which are produced as a result of the changes in direction or the diverting of the stone blocks 2, are shown in FIG. 2 as an example and in a schematic manner just at individual stone blocks 2. It can also be seen from FIG. 2 that as a result of the third section 103, that is to say the second opposite change in direction, a collision is obtained once again between a front vertically extending stone block edge of a following stone block 2 and a rear vertically extending stone block edge of a preceding stone block 2. All in all, when the ageing duct 1 comprises three sections 101, 102, 103, that is to say the ageing duct 1 forces the stone blocks 2 to change direction two times, the achievement is that all the vertically extending stone block edges 200c, 200d of the stone block 2 are consequently aged by a collision with an adjoining, preceding or following, stone block 2. In addition, this is not shown in any detail in FIG. 2, the vertically extending stone block edges 200c, 200d of a stone block 2 of a row of stone blocks 10, 11, 12 also strike against stone blocks 2 of rows of stone blocks 10,11,12 which are adjacent and located side by side such that the vertical stone block edges 200c, 200d of a stone block 2 are treated not only on account of the collision with a following or preceding stone block 2 of the same row of stone blocks 10, 11, 12, but also on account of a collision with stone blocks 2 of further rows of stone blocks 10, 11, 12 which are located side by side.

The achievement of the change in direction between the sections 101, 102, 103 is that the rear surface 203 of a preceding stone block 2 is displaced against the front surface 200 of a following stone block 2. As a result, the rear surface 203 of the preceding stone block 2 rubs against the front surface 200 of the following stone block 2, as a result of which—strengthened by vibration—they treat one another in a reciprocally abrasive manner and an ageing effect is consequently achieved. This also applies, in particular, to the circumferential edges of the stone blocks 2.

The feed device 9 shown in FIGS. 1 and 2 in order to convey the stone blocks 2 through the ageing duct 1, can be developed in an arbitrary manner. In the exemplary embodiment, it is provided that the feed device 9 comprises a punch. A plurality of variants is conceivable for conveying the stone blocks 2 through the ageing duct 1, for example it is possible to use a chain conveyor which engages in the ageing duct 1 from above or below through corresponding recesses and conveys the stone blocks 2 in the feed direction.

The base 4 of the ageing duct 1 can be realized in one embodiment as a support of a vibration table. The important point is simply that an ageing duct 1 is created, through which the stone blocks 2 are able to be pushed.

The feed device 9 can push the stone blocks 2, in principle, continuously, but also at intervals, through the ageing duct 1. It has proved to be particularly suitable when the feed device 9 pushes the stone blocks 2 at intervals though the ageing duct 1, new stone blocks 2 are continually added from behind such that practically an endless train of stone blocks 2 or rows of stone blocks 10, 11, 12 is formed. The feed at intervals is preferably developed in such a manner that the feed device 9 pushes the stone blocks 2 forward over a defined path section or for a defined time, for example for a period of between 2 and 5 seconds, and then the feed device 9 stops and preferably reverses a little. The stopping and in particular reversing of the feed device 9 makes it possible for the stone blocks 2 lying on the base 4 to be shaken free. On account of the vibration of the stone blocks 2, which is preferably effected continuously, the stone blocks 2 are also moved somewhat against the feed direction when the feed device 9 is reversed. The stone blocks 2 are consequently spaced closer together on account of the vibration. This improves the ageing result and avoids the stone blocks 2 jamming in the ageing duct 1. During the next thrust, the stone blocks 2 are pushed closely together again such that, once again, a correspondingly desired stop is effected also in particular as a result of the vibration. During the next stopping or reversing of the feed device 9, the stone blocks 2 can be shaken free again. At the end of the rows of stone blocks 10, 11, 12, new stone blocks 2 are at the same time connected to the end of the rows of stone blocks 10, 11, 12 in regular cycles or continuously by the feed device 9 or by means of other measures.

It is advantageous when the vertical spacing between the upper boundary 5 and the base 4 of the ageing channel 1 is chosen in such a manner that, brought about by the vibration, the stones blocks 2 strike against the upper boundary 5.

In principle, the ageing appearance of the stone blocks can be influenced by the intensity of the vibration and the suitable choice of the spacing between the base 4 and the upper boundary 5 of the ageing duct 1.

In the exemplary embodiment, it is preferably provided that the upper boundary 5 completely covers or conceals the rows of stone blocks 2 to be guided through the ageing duct 1 from above.

The upper boundary 5 is preferably realized as an upper cover. The upper cover 5 preferably closes the ageing duct 1 at the top.

It is provided in the exemplary embodiment that the base 4 of the ageing channel 1 comprises at least one elevation 13. However, the invention is not restricted to this. The elevation 13 can be arbitrarily developed, for example it can be, for example, small island-shaped elevations 13 or one or several ramps. Points or stops can also project out of the base 4. These can also be designated as elevation 13. The elevations 13 can also be chicanes or the like. The elevation in the exemplary embodiment is developed as an example in the shape of a ramp and extends from a lateral boundary 6 up to the oppositely situated lateral boundary 7. The elevation consequently extends transversely with respect to the feed direction. The elevation can also extend, however, at a different angle. The ramp-shaped elevation can be arbitrarily long or short. The elevation 13, in this case, can be developed similarly to the ramps which are known from road construction and are used to reduce speed.

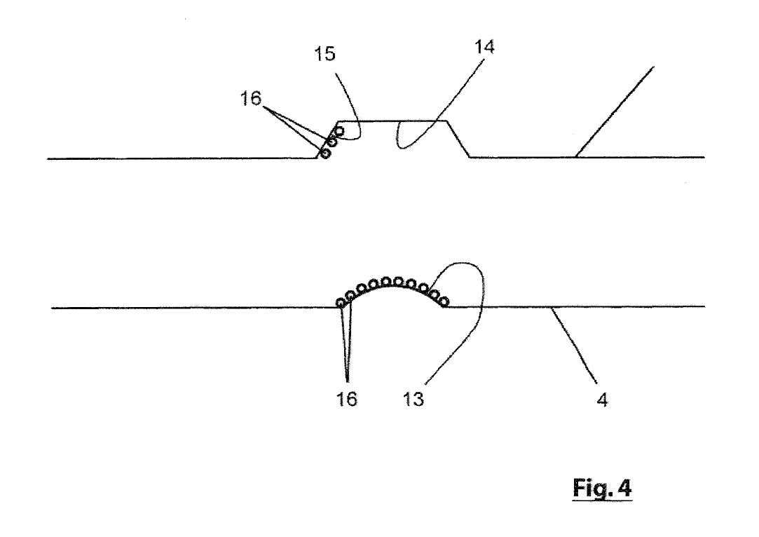

As can be seen in particular from FIG. 4, the upper boundary 5 comprises a rise 14 in the region above the elevation 13 in the base 4 of the ageing duct 1 in order to make it possible for the stone blocks 2 to be raised by the elevation 13. In the region of the elevation 13, in the exemplary embodiment the ramp, the upper boundary 5 of the ageing duct 1 is consequently raised. As can be seen additionally from FIG. 4, it is advantageous in this case when the rise 14 realizes a stop edge 15. The stone blocks 2, in particular by way of the stone block top edge 200b, can strike against the stop edge 15 when the stone blocks 2 are raised by the elevation 13. The elevation 13 also results in the stone block bottom edge 200a being correspondingly knocked against and treated.

In the exemplary embodiment, it is provided that several elevations 13 developed in a ramp-shaped manner are arranged one after another in the throughput direction such that the stone blocks 2 are raised multiple times. In this case, it can also be provided that the elevations 13 are positioned in such a manner that the stone blocks 2 are not raised in a uniform manner, but, for example, only on the left-hand side or on the right-hand, as a result of which a specific ageing appearance is able to be generated.

The base 4 and/or the elevation 13 and/or the upper boundary 5 and/or the rise 14 and/or the stop edge 15 and/or the lateral boundaries 6, 7 can be provided with stop projections 16 and/or abrasive elements and/or weld points and/or weld beads. An irregular structure or an abrasive surface can also be provided.

The ageing duct 1 can be broadly provided on its inside surface with the above-mentioned stop projections 16 or the like.

Within the framework of the invention, additional stop members can also be provided which are positioned in a stationary manner and/or are positionable in a controlled manner such that bevels and/or recesses and/or phases of stone block surfaces to be treated, in the exemplary embodiment of the front surface 200 and/or of the rear surface 203, knock against them, as a result of the vibration of the base 4.

The stop members can be developed in an arbitrary manner and introduced into the feed path of the stone blocks 2. As a result, further processing effects, in particular on the front surface 200 or the rear surface 203 of the stone blocks 2, can be performed, for example in order to introduce scratches or the like at that location.

The angle between the first section 101 and the second section 102 and/or between the second section 102 and the third section 103 can be, for example, between 1° and 45°, preferably between 1° and 25°, in a further preferred manner between 1° and 15°, in a particularly preferred manner between 1° and 10° and quite especially preferred between 3° and 7°.

The choice of a suitable angle can be chosen in dependence on the hardness of the stone block 2, the intensity of the vibration and the desired ageing result. The deflection is preferably small.

The description serves in an analogous manner for explaining the method according to the invention and for a possible realization of the use according to the invention.

It has been proved as advantageous when the stone blocks 2 are moved somewhat after running through the ageing duct 1 so that they are spaced apart or the stone blocks 2 are divided into singles such that a gap is created between the stone blocks 2, through which it is then possible, with the assistance, for example, of a blower or another measure, to blow out dust and stone block residue which has accumulated between the stone blocks 2 through the ageing process.

The trapezoidal stone blocks 2 of the rows of stone blocks 10,11,12 can be introduced into the ageing duct 1 such that in each case the front surface 200 is situated in the front in the feed direction. However, it is also possible for one row of stone blocks (e.g. 10) to be aligned such that the stone blocks 2 thereof are aligned in each case with the front surface 200 to the front, whilst the stone blocks 2 of the adjoining row of stone blocks (e.g. 11) are arranged rotated by 180°, that is to say that the rear surface 203 is aligned to the front in the feed direction. The second row of stone blocks (e.g. 12) adjoining the row of stone blocks 11 is then once again aligned rotated by 180°, corresponding to the first adjoining row of stone blocks (e.g. 10). It can prove to be advantageous for achieving a specific ageing appearance to align the rows of stone blocks 10, 11, 12 in each case rotated by 180°, as described above. That is to say in the case of one row of stone blocks, the shorter basic surface is aligned to the front and in the case of the other row of stone blocks, in each case it is the longer basic surface.

What is claimed is:

1-23. (canceled)

24. A device for artificially ageing stone blocks, in particular concrete blocks, clinker bricks and natural stone blocks, said device having the following features:
(a) an ageing duct which comprises a base, an upper boundary and lateral boundaries;
(b) a vibration device in order to make at least the base of the ageing duct vibrate; and
(c) a feed device in order to convey at least two rows of stone blocks, which are arranged side by side in the feed direction and are formed in each case by several stone blocks placed one behind the other, through the ageing duct, wherein the stone blocks of the rows of stone blocks are placed in such a manner on the base of the ageing duct that the stone block surface of the stone blocks to be treated is aligned transversely with respect to the feed direction.

25. A device as claimed in claim 24, wherein the ageing duct comprises at least two sections, wherein the stone blocks run through a first section in a first feed direction and wherein a second section extends at an angle to the first section such that the feed direction of the stone blocks is deflected and they are moved in a second feed direction.

26. A device as claimed in claim 25, wherein the ageing duct comprises at least one third section, wherein the third section extends at an angle to the second section such that the stone blocks are once again deflected and are moved in a third feed direction.

27. A device as claimed in claim 24, wherein the feed device advances the rows of stone blocks at intervals, wherein one interval includes advancing the feed device, stopping and preferably reversing the feed device in order to enable the stone blocks to be shaken free.

28. A device as claimed in claim 24, wherein the vertical spacing between the upper boundary and the base of the ageing duct is chosen in such a manner that, brought about by the vibration, the stone blocks strike against the upper boundary.

29. A device as claimed in claim 24, wherein the upper boundary completely covers the stone blocks of the rows of stone blocks situated in the ageing duct.

30. A device as claimed in claim 24, wherein the base of the ageing duct is provided with at least one elevation.

31. A device as claimed in claim 30, wherein the upper boundary comprises a rise in the region above the elevation in order to enable the stone blocks to be raised by the elevation in the base.

32. A device as claimed in claim 31, wherein the rise realizes a stop edge.

33. A device as claimed in claim 24, wherein the base and/or the elevation and/or the upper boundary and/or the stop edge and/or the lateral boundaries are provided with stop projections and/or abrasive elements and/or weld points and/or weld beads and/or an abrasive surface.

34. A device as claimed in claim 24, wherein the ageing duct comprises a width which extends transversely with respect to the feed direction and makes it possible to push at least two rows of stone blocks arranged side by side, preferably one complete layer of stone blocks, through the ageing duct.

35. A device as claimed in claim 24, wherein in the top view the stone blocks comprise the form of a trapezium, wherein the trapezoidal stone blocks are placed in such a manner onto the base of the ageing duct that the basic surfaces of the trapezoidal stone blocks extending parallel to one another are aligned transversely with respect to the feed direction.

36. A method for artificially ageing stone blocks, in particular concrete blocks, clinker bricks and natural stone blocks, said method having the following features:
(a) according to which the stone blocks are conveyed through an ageing duct and the stone blocks are placed in this case in such a manner on a base of the ageing duct that a stone block surface of the stone blocks to be treated is aligned transversely with respect to the feed direction of the stone blocks through the ageing duct;
(b) according to which several stone blocks placed one behind another are combined to form a row of stone blocks and at least two rows of stone blocks arranged side by side with reference to the feed direction are pushed together through the ageing duct; and
(c) according to which the stone blocks, whilst they are being pushed through the ageing duct, are made to vibrate such that the stone blocks strike against an upper boundary of the ageing duct.

37. A method as claimed in claim 36, wherein at least one change in direction is forced on the stone blocks which run through the ageing duct.

38. A method as claimed in claim 37, wherein at least two changes in direction are forced on the stone blocks which run through the ageing duct.

39. A method as claimed in claim 36, wherein the vertical spacing between the upper boundary and the base of the ageing duct is adapted in such a manner to the height of the stone blocks that the stone blocks strike against the upper boundary as a result of the vibration.

40. A method as claimed in claim 36, wherein the stone blocks are pushed by a feed device through the ageing duct at intervals, according to which one interval includes advancing the feed device in the feed direction, stopping and preferably reversing the feed device against the feed direction in order to enable the stone blocks to be shaken free.

41. A method as claimed in claim 36, wherein the stone blocks run over at least one elevation whilst being pushed through the ageing duct and, as a result, strike against the upper boundary.

42. A method as claimed in claim 36, wherein in top view the stone blocks comprise the form of a trapezium, wherein the stone blocks are aligned in such a manner prior to being pushed through the ageing duct that the basic surfaces of the trapezoidal stone blocks extending parallel to one another are aligned transversely with respect to the feed direction.

43. A method as claimed in claim 36, wherein at least one of the stone block surfaces of the stone blocks to be treated is a stone block surface produced as a result of splitting.

44. The use of a device for artificially ageing stone blocks, in particular concrete blocks, clinker bricks and natural stone blocks, of a type which, in top view, comprise the form of a trapezium, wherein the device comprises:
(a) an ageing duct with a base, an upper boundary and lateral boundaries, wherein the stone blocks are placed in such a manner onto the base that a stone block surface of the stone blocks to be treated is aligned transversely with respect to the feed direction of the stone blocks through the ageing duct;
(b) a feed device in order to convey the stone blocks through the ageing duct; and
(c) a vibration device in order to make the stone blocks vibrate whilst they are being pushed through the ageing duct such that the stone blocks strike against the upper boundary of the ageing duct.

45. A use as claimed in claim 44, wherein the ageing duct comprises at least two sections, wherein the stone blocks run through a first section in a first feed direction and wherein a second section extends at an angle to the first section such that the feed direction of the stone blocks is deflected and they are moved in a second feed direction.

46. A use as claimed in claim 44, wherein at least one of the stone block surfaces of the stone blocks to be treated is a stone block surface produced as a result of splitting.
